(19) United States
(12) Patent Application Publication
(10) Pub. No.: US 2025/0139231 A1
(43) Pub. Date: May 1, 2025

(54) APPLICATION BEHAVIOR POLICY VALIDATION

(71) Applicant: Google LLC, Mountain View, CA (US)

(72) Inventors: Fergus Gerard Hurley, Miami, FL (US); Jay Michael Kornder, II, New York, NY (US); Hamza Harkous, Zürich (CH); Nia J.C. Castelly, San Jose, CA (US); James Yum, Irvine, CA (US); Sherzat Aitbayev, New York, NY (US); Helton de Melo Duarte, Kirkland, WA (US); Evan Logan Otero, Cambridge, MA (US); Rory Alan Jacobs, Irvine, CA (US)

(21) Appl. No.: 18/835,556

(22) PCT Filed: Apr. 12, 2022
(86) PCT No.: PCT/US2022/071678

§ 371 Date: Aug. 2, 2024

Related U.S. Application Data
(60) Provisional application No. 63/268,304, filed on Feb. 21, 2022.

(51) Int. Cl. G06F 21/54; G06F 21/55

(52) U.S. Cl. CPC G06F 21/54; G06F 21/552

(57) ABSTRACT

A computing system is described that includes a memory that stores one or more modules and one or more processors. The one or more processors, when executing the one or more modules, are configured to determine, based on application policy information for an application, one or more application policies for the application, monitor execution of the application to determine a set of application behaviors, compare the set of application behaviors to the one or more application policies, and output an indication of whether one or more application behaviors from the set of application behaviors are consistent with the one or more application policies.

### BACKGROUND

Software developers, such as application developers, software development kit developers, etc. are being held responsible for the behaviors of the software they develop by application hosting services, end users, and others. For example, many application hosting services are requiring the software developers to describe how the software uses and shares information about a user of the software. The application hosting services may wish to confirm that the software is behaving as described by the developers. Similarly, end users may like to be able to confirm that the application they downloaded and installed is actually operating as described. Further, applications operating differently than anticipated or described may pose a security risk. For example, companies who develop internal applications may want to verify that the internal applications are not sending sensitive information outside of the company. Performing such checks is difficult and time consuming.

### SUMMARY

In general, techniques of this disclosure are directed to an application behavior validation system that may automatically parse application policy information and monitor application behaviors to identify potential discrepancies between the stated policy and the actual operation of the application. The system may use natural language processing techniques to parse the application policy information to identify relevant application behaviors set forth in the policy. The system may then monitor the operation of the application by, for example, monitoring network traffic and monitoring information displayed by the device on which the application is executing, and compare the results of the monitoring to the identified behaviors. If there is a potential discrepancy (e.g., an application is sending personally identifiable information to a remote computing system when the policy said that no such information was sent off of the device), the system may alert the developer, application hosting service provider, end user, corporation, etc. of the potential issue for remediation. In this way, the techniques of this disclosure may automatically identify potentially undesired application behaviors, which may increase data and information security.

In one example, this disclosure describes a method that includes determining, by a computing system and based on application policy information for an application, one or more application policies for the application, and monitoring, by the computing system, execution of the application to determine a set of application behaviors. The method may also include comparing, by the computing system, the set of application behaviors to the one or more application policies, and outputting, by the computing system, an indication of whether one or more application behaviors from the set of application behaviors are consistent with the one or more application policies.

In another example, a computing device includes a memory and one or more processors operably coupled to the memory and configured to determine, based on application policy information for an application, one or more application policies for the application and monitor execution of the application to determine a set of application behaviors. The one or more processors may be further configured to compare the set of application behaviors to the one or more application policies, and output an indication of whether one or more application behaviors from the set of application behaviors are consistent with the one or more application policies.

In another example, a non-transitory computer-readable storage medium is encoded with instructions that, when executed by one or more processors of a computing device, cause the one or more processors to determine, based on application policy information for an application, one or more application policies for the application and monitor execution of the application to determine a set of application behaviors. The instructions may further cause the one or more processors to compare the set of application behaviors to the one or more application policies, and output an indication of whether one or more application behaviors from the set of application behaviors are consistent with the one or more application policies

In another example, a computing device includes means for determining, based on application policy information for an application, one or more application policies for the application, and means for monitoring execution of the application to determine a set of application behaviors. The computing device may also include means for comparing the set of application behaviors to the one or more application policies, and means for outputting an indication of whether one or more application behaviors from the set of application behaviors are consistent with the one or more application policies.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example application behavior validation system, in accordance with one or more aspects of the present disclosure.

FIG. 2 is a block diagram illustrating an example computing system for identifying application behavior policies and monitoring application behaviors, in accordance with one or more aspects of the present disclosure.

FIG. 3 is a flowchart illustrating an example mode of operation for an application behavior validation system, in accordance with one or more aspects of the present disclosure.

### DETAILED DESCRIPTION

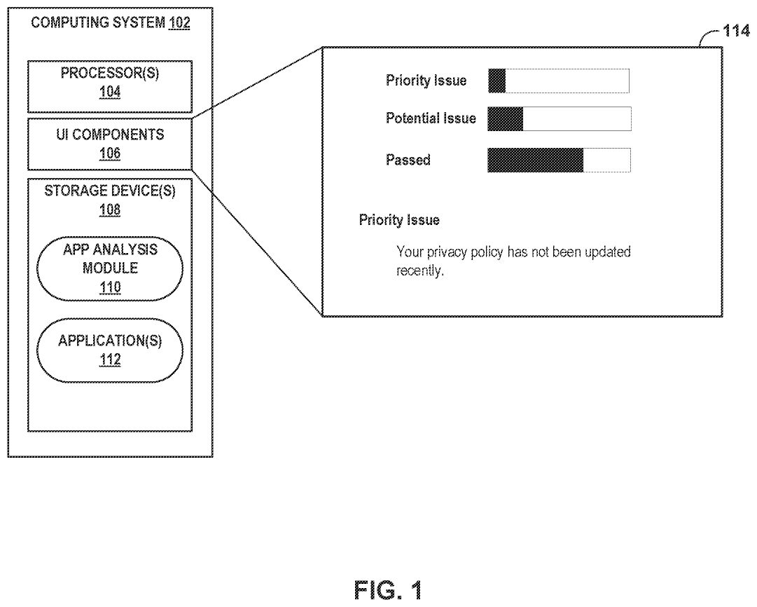

FIG. 1 is a block diagram illustrating an example application behavior validation system, in accordance with one or more aspects of the present disclosure. The application behavior validation system includes computing system 102. In some examples, computing system 102 may include stationary computing devices such as desktop computers, servers, mainframes, cloud computing systems, etc., and may be in communication with remote computing systems, such as a developer device, end user device, or other devices, over one or more networks.

As shown in FIG. 1, computing system 102 includes processors 104, user interface (“UI”) components 106 and storage devices 108. Storage devices 108 includes application (“app”) analysis module 110 and applications 112. One or more processors 104 may implement functionality and/or execute instructions associated with computing system 102. Examples of processors 104 include application processors, microcontrollers, central processing units (CPUs), field programmable gate arrays (FPGAs), application specific integrated circuits (ASICs), graphics processing units (GPUs), display controllers, auxiliary processors, one or more sensor hubs, and any other hardware configure to function as a processor, a processing unit, or a processing device. App analysis module 110 and applications 112 may be operable (or, in other words, executed) by processors 104 to perform various actions, operations, or functions of computing system 102. That is, app analysis module 110 and applications 112 may form executable bytecode, which when executed, cause processors 104 to perform specific operations (and thereby causing computing system 102 to become a specific-purpose computer by which to perform) in accordance with various aspects of the techniques described herein. For example, processors 104 of computing system 102 may retrieve and execute instructions stored by storage devices 108 that cause processors 104 to perform the operations described herein that are attributed to app analysis module 110 and applications 112. The instructions, when executed by processors 104, may cause computing system 102 to store information within storage devices 108.

Storage device 108 may store information for processing during operation of computing system 102 (e.g., computing system 102 may store data accessed by app analysis module 110 and applications 112 during execution at computing system 102). In some examples, storage device 108 is a temporary memory, meaning that a primary purpose of storage device 108 is not long-term storage. Storage device 108 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage device 108, in some examples, also includes one or more computer-readable storage media. Storage device 108 may include one or more non-transitory computer-readable storage mediums. Storage device 108 may be configured to store larger amounts of information than typically stored by volatile memory. Storage device 108 may further be configured for long-term storage of information as non-volatile memory space and retain information after power on/off cycles. Examples of non-volatile memories include magnetic hard disks, optical discs, flash memories, or forms of electrically programmable memories (EPROM) or electrically erasable and programmable (EEPROM) memories. Storage device 108 may store program instructions and/or information (e.g., data) associated with app analysis module 110 and applications 112. Storage devices 108 may include a memory configured to store data or other information associated with app analysis module 110 and applications 112

UI components 106 of computing system 102 may function as an input device for computing system 102 and as an output device. For instance, UI components 106 may function as an input device using a resistive touchscreen, a surface acoustic wave touchscreen, a capacitive touchscreen, a projective capacitance touchscreen, a pressure sensitive screen, an acoustic pulse recognition touchscreen, or another presence-sensitive screen technology. UI components 106 may function as an output device using any one or more of a liquid crystal display (LCD), dot matrix display, light emitting diode (LED) display, microLED, organic light-emitting diode (OLED) display, e-ink, or similar monochrome or color display capable of outputting visible information to the user of computing system 102. For example, UI components 106 may include a display.

In some examples, the display may be a presence-sensitive screen that may receive tactile user input from a user of computing system 102. UI components 106 may receive the tactile user input by detecting one or more taps and/or gestures from a user of computing system 102 (e.g., the user touching or pointing to one or more locations of UI components 106 with a finger or a stylus pen). The presence-sensitive screen of UI components 106 may present output to a user. UI components 106 may present the output as a user interface, such as graphical user interface (“GUI”) 114, which may be related to functionality provided by computing system 102. For example, UI components 106 may present various functions and applications executing on computing system 102 such as report generation application, an electronic message application, a messaging application, a map application, etc.

Applications 112 may be applications that are accessible to computing system 102, either locally or remotely. While shown in FIG. 1 as being stored locally at computing system 102 by storage device 108, in various examples, one or more applications 112 may be stored at remote computing devices communicatively coupled to computing system 102 via a network.

Each of applications 112 may be provided by various software developers and may use libraries, software development kits, and other functionality provided by a developer other than the developer of the particular application. Each of applications 112 may be associated with a policy, such as a privacy policy, security policy, etc. For example, one or more of applications 112 may be made available in an application store for download and installation by an end user. To be included in the application store listings, the developer may be required to describe various behaviors of the application, such as how the application is using personally identifiable data. Such a description may be included in the application store listing for review by an end user prior to downloading and installing the application. In other examples, one of applications 112 may be a custom application developed for a company. The company may require the developer to follow certain security and data privacy requirements. However, it may be difficult for the company, the application store provider, or the end user to verify that the developers are actually complying with the stated policies.

In accordance with techniques of this disclosure, app analysis module 110 executing at computing system 102 may analyze the written policies associated with each of applications 112, identify various characteristics of the various policies, monitor the behavior of each of applications 112, compare the monitored behaviors of each application 112 with the corresponding policy, and generate a report setting forth the results (e.g., GUI 114), including any discrepancies between the stated policies and the actual application behaviors. App analysis module 110 may retrieve the application policy information from one or more remote computing devices, from a data store within storage device 108, or from any other source, App analysis module 110 may determine the contents of the application policies by applying one or more natural language processing (“NLP”) classification models to the application policies. The NLP classification models may classify portions of the application policies into different high-level categories of segments in the policy, different types of information mentioned in the policy, and/or different purposes of data usage mentioned in the policy.

App analysis module 110 may monitor behaviors of one or more applications 112. For example, app analysis module 110 may monitor network traffic generated by one or more of applications 112, the type of information collected, stored, and transmitted by the one or more applications 112, and/or information generated by one or more of applications 112 for display by the computing device on which the application is installed. In various examples, app analysis module 110 may generate an application behavior report based on the monitored behaviors. The application behavior report may include detailed information about what data is collected by the application, what data is sent to a remote system by the application, what data is stored by the application, etc. In some instances, the application behavior report may be a log file in addition to or rather than a report that is displayed to a user.

In instances where app analysis module 110 is executed on an end user device (e.g., monitoring an application installed on the end user device by the end user), app analysis module 110 may not monitor behaviors of one or more applications 112 without prior authorization by the end user. Throughout the disclosure, examples are described where a computing device and/or a computing system analyzes information (e.g., content displayed, context, locations, speeds, search queries, etc.) associated with a computing device and a user of a computing device, only if the computing device receives permission from the user of the computing device to analyze the information. For example, before a computing device or computing system can collect or may make use of information associated with a user, including for purposes of determining if an application is operating in accordance with a stated policy for that application, the user may be provided with an opportunity to provide input to control whether programs or features of the computing device and/or computing system can collect and make use of user information (e.g., information about a user's current location, current speed, email address, phone number, mailing address, etc.), or to dictate whether and/or how to the device and/or system may receive content that may be relevant to the user. In addition, certain data may be treated in one or more ways before it is stored or used by the computing device and/or computing system, so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device and computing system.

App analysis module 110 may compare the information included in the application behavior report to the application policy information and determine any application behaviors that are consistent, inconsistent, or potentially inconsistent with the application policy as well as any changes in the application behaviors compared to prior versions of the application (e.g., following an application update). Using this comparison, app analysis module 110 may generate a report (e.g., as shown in GUI 114) that provides information about the various potential issues as well as application behaviors that are in line with the application policy information. While described as application behaviors, app analysis module 110 may also identify other potential issues with the application policy information and include those potential issues in the report.

As shown in GUI 114, app analysis module 110 identified one or more priority issues, one or more potential issues, and several instances where the application behavior was consistent with the application policy information. GUI 114 includes information about a privacy policy of the application not having been updated recently as one example of a priority issue. Other priority issues may include data used by the application in a way that is inconsistent with the application policy information (e.g., sending personally identifiable information to a remote server where the application policy specified that no such information is sent to a remote server, etc.). Potential issues may include new types of data being collected, instances where app analysis module 110 was not able to confidently determine if an application behavior was consistent or inconsistent with the application policy information, etc. Passed items include application behaviors that app analysis module 110 determined with a sufficient degree of confidence (e.g., over a threshold confidence level) are consistent with the application policy information.

By automatically parsing application policy information and comparing application behaviors to the application policy information, techniques of this disclosure may enable application store providers, companies, end users, the application developer itself, etc. to more easily determine if the application is operating as described. These techniques may increase data privacy and security by enabling the application developer to more easily identify and correct bugs or other unintentional application behaviors. Further, an end user may use such information to decide to uninstall applications that are behaving differently than anticipated, which may protect the user's privacy.

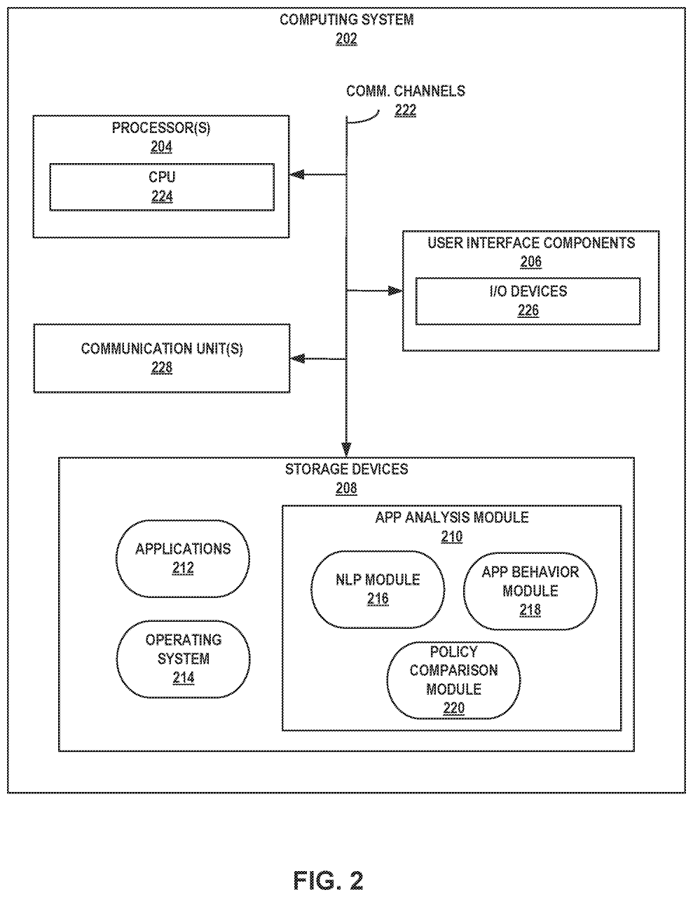

FIG. 2 is a block diagram illustrating an example computing system for identifying application behavior policies and monitoring application behaviors, in accordance with one or more aspects of the present disclosure. FIG. 2 illustrates one example of computing system 102, as illustrated in FIG. 1. Computing system 202 may include desktop computers, servers, mainframes, etc., and may be in communication with remote computing systems over one or more networks. Many other examples of computing system 202 may be used in other instances and may include a subset of the components included in example computing system 202 or may include additional components not shown in FIG. 2.

As shown in the example of FIG. 2, computing system 202 includes processors 204, one or more input/output components, such as user interface components (UIC) 206, one or more communication units 228, and one or more storage devices 208. Storage devices 208 of computing system 202 may include app analysis module 210, applications 212, and operating system 214, and UIC 206 may include I/O (input/output) devices 226. App analysis module 210 may include natural language processing (“NLP”) module 216, application (“app”) behavior module 218, and policy comparison module 220.

The one or more communication units 228 of computing system 202, for example, may communicate with external devices by transmitting and/or receiving data at computing system 202, such as to and from remote computer systems. For example, computing system 202 may receive, using communication units 228, one or more applications 112 for installation and testing. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 222 may interconnect each of the components as shown for inter-component communications (physically, communicatively, and/or operatively). In some examples, communication channels 222 may include a system bus, a network connection (e.g., to a wireless connection as described above), one or more inter-process communication data structures, or any other components for communicating data between hardware and/or software locally or remotely.

One or more storage devices 208 within computing system 202 may store information, such as data associated with applications 212 and other data discussed herein, for processing during operation of computing system 202. In some examples, one or more storage devices of storage devices 208 may be a volatile or temporary memory. Examples of volatile memories include random access memories (RAM), dynamic random-access memories (DRAM), static random-access memories (SRAM), and other forms of volatile memories known in the art. Storage devices 208, in some examples, may also include one or more computer-readable storage media. Storage devices 208 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 208 may store program instructions and/or data associated with the operating system 214 and applications 212, and app analysis module 210.

One or more I/O devices 226 of computing system 202 may receive inputs and generate outputs. Examples of inputs are tactile, audio, kinetic, and optical input, to name only a few examples. Input devices of I/O devices 226, in one example, may include a touchscreen, a touch pad, a mouse, a keyboard, a voice responsive system, a video camera, buttons, a control pad, a microphone or any other type of device for detecting input from a human or machine. Output devices of I/O devices 226, may include, a sound card, a video graphics adapter card, a speaker, a display, or any other type of device for generating output to a human or machine.

Applications 212 may be any type of applications that may be executed by computing system 202 or other computing devices. In some examples, applications 212 include web-based applications (e.g., applications that execute within a browser application), applications that are executed partially at computing system 202 and partially at a remote computing system, applications that are streamed to computing system 202 from a remote computing device, applications that are at least partially installed at computing system 202, or any other type of application.

App analysis module 210 may perform operations described herein using software, hardware, firmware, or a mixture of both hardware, software, and firmware residing in and executing on computing system 202 or at one or more other remote computing devices (e.g., cloud-based application—not shown). Computing system 202 may execute app analysis module 210, such as NLP module 216, app behavior module 218, and policy comparison module 220, with one or more processors 204 or may execute any or part of app analysis module 210 as or within a virtual machine executing on underlying hardware. App analysis module 210 may be implemented in various ways, for example, as a downloadable or pre-installed application, remotely as a cloud application or as part of operating system 214 of computing system 202. Other examples of computing system 202 that implement techniques of this disclosure may include additional components not shown in FIG. 1 or 2.

In the example of FIG. 2, one or more processors 204 may implement functionality and/or execute instructions within computing system 202. For example, one or more processors 204 may receive and execute instructions that provide the functionality of UIC 206, communication units 228, and one or more storage devices 208 and operating system 214 to perform one or more operations as described herein. The one or more processors 204 include central processing unit (CPU) 224. Examples of CPU 224 include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or other processing device, an application specific integrated circuit (ASIC), a field programmable logic array (FPGA), or other equivalent integrated or discrete logic circuitry, or other equivalent integrated or discrete logic circuitry.

One or more processors 204 may implement functionality and/or execute instructions within computing system 202. For example, one or more processors 204 may receive and execute instructions that provide the functionality of some or all of app analysis module 210 to perform one or more operations and various functions described herein parse application policy information, monitor the behavior of one or more applications 212 during execution, and compare the behaviors of applications 212 to the behaviors set forth in the application policy information.

NLP module 216 may include one or more classification models (also referred to herein as “classifiers”) that classify information included within application policy information. NLP module 216 may apply the classifiers to determine what the topic of a paragraph-level segment of the application policy information discusses (e.g., third party sharing or data retention), determine the data types mentioned in the application policy, and determine the purpose of data used by the application.

In various examples, NLP module 216 may train the classification models, update the classification models, and/or obtain trained classification modules from a remote computing system. In instances where NLP module 216 trains the classification models, NLP module 216 may use retrieval-assisted label model building. That is, NLP module 216 may index a series of application policies and query the index for some particular type of data. After retrieving the results of the query, NLP module 216, with human assistance, may label the results to generate an initial training dataset. Using this initial training dataset, NLP module 216 may train the classification models on binary classification. For example, the initial training dataset may include policy information, a potential type of the policy information, and a binary indication (e.g., yes or no) the policy information is of the potential type. After completing this initial training stage, NLP module 216 may then use this initial set of trained classifier models to train a multi-label classifier model that can take a segment of an application policy as an input and output all of the labels that apply to that particular segment. As new types of policy information and/or data appear, the initial classification models can be updated with new training data and the subsequent classifiers can be updated using the updated initial classification models. In this way, the classification models applied by NLP module 216 may be easily updated with additional policy information and data types that may arise over time.

App behavior module 218 may interact with one or more applications 212 in a manner consistent with an end user. App behavior module 218 may automate various interactions with one or more applications 212 and monitor the resulting behaviors of one or more applications 212. In various instances, applications 212 may not be stored locally at computing system 202. Instead, app behavior module 218 may send commands to a bank of real or virtual devices that each execute one or more applications 212 and may monitor the resulting activity of those applications and/or receive application behavior information determined by the real or virtual devices.

App behavior module 218 may monitor how each of applications 212 use data, including what data is stored by applications 212, what data is sent over a network to a remote computing system by applications 212, what information is included in graphical user interfaces of applications 212, what data is collected by applications 212 (e.g., from an end user), what software development kits (SDKs) are used by applications 212, what device permissions (e.g., using a camera of the device, using location information of the device, etc.) are requested by applications 212, etc. in various instances, app behavior module 218 may store the monitored application behavior information for analysis by policy comparison module 220.

Policy comparison module 220 may compare the application policy information determined by NLP module 216 to the application behavior information generated by app behavior module 218 to determine whether one or more of applications 212 are operating consistently with the application policy information associated with the respective application 212. In various examples, policy comparison module 220 may generate a report based on the comparison between the application policy information and the application behavior information. An application store provider, a compliance professional, an end user, a developer, or any other person or entity may review the report and take appropriate actions based on the report. For example, the application store provider may reject an application listing if the application does not behave in accordance with the specified application policy. As another example, a developer may determine that there is a bug in the application because information is being used in an unintended way. As another example, an end user may decide to uninstall an application because the application does not operate in accordance with the user's preferred privacy policy.

Rather than being provided by a developer, the application policy information may be user specific (i.e., a set of user specified application policy information). For example, an end user may configure a device with particular data privacy policies that reflect the amount of data sharing the end user finds acceptable. The data privacy policy may include types of information that may be shared, with whom the information may be shared, the level of specificity of the information that may be shared, among other things. The techniques described above may be applied to such user-defined policies and may provide user-specific reports about the application behaviors as compared to the user's desired application policies.

In some examples, the application policy information may be provided and the app analysis module 210 may be executed by a third party different from the software developer, the application store provider, and the end user. As one example, a third party may develop a set of privacy policies and analyze the behaviors of various applications relative to that third part specified application policy information. As another example, rather than requiring an end user, developer, or application store provider to directly trigger the application behavior validation process described herein, a third party may be contracted or otherwise engaged to perform this application behavior validation process.

In some examples, each application may also be associated with a data label. The data label may be a simplified description of particular privacy policies and device permissions set forth in a table or other format. While described throughout as analyzing application policy information, app analysis module 210 may also analyze such data labels and compare the application policies determined from the data labels to the application behaviors. Further, app analysis module 210 may generate a separate report that includes the results of the comparison between the application behaviors and the policies set forth in the data label and/or may include such information within the application policy report described above.

App analysis module 210 may be executed on a periodic schedule, on demand, or in response to a change in an application. For example, a developer may, using an integrated development environment (IDE), trigger app analysis module 210 to execute and generate the application policy and behavior report as part of the development process. As another example, an application store service provider may periodically (e.g., daily, weekly, monthly, etc.) cause app analysis module 210 to execute and analyze all or a portion of the applications submitted for approval for listing on the application store. As another example, app analysis module 210 may be automatically triggered to execute each time an application is updated or the application policy for the application is updated.

Rather than just analyzing existing policy information and determining if an application is operating consistently with the policy, in some examples, app analysis module 210 may analyze the application behaviors and dynamically generate the application policy information based on the observed behaviors. For example, app behavior module 218 may determine that an application does not share any personally identifiable information with remote servers. App analysis module 210 may generate one or more sentences, a table, or some other format that includes information stating that the application does not share personally identifiable information. As another example, app analysis module 210 may generate a list of SDKs used by the application, a list of remote servers with which the application sends or receives data, a list of the types of information collected by the application, etc. In this way, the techniques of this disclosure not only enable a computing system to determine whether or not an application behaves in accordance with application policy information, but also may assist a developer, application store provider, or other entity in creating the application policy information.

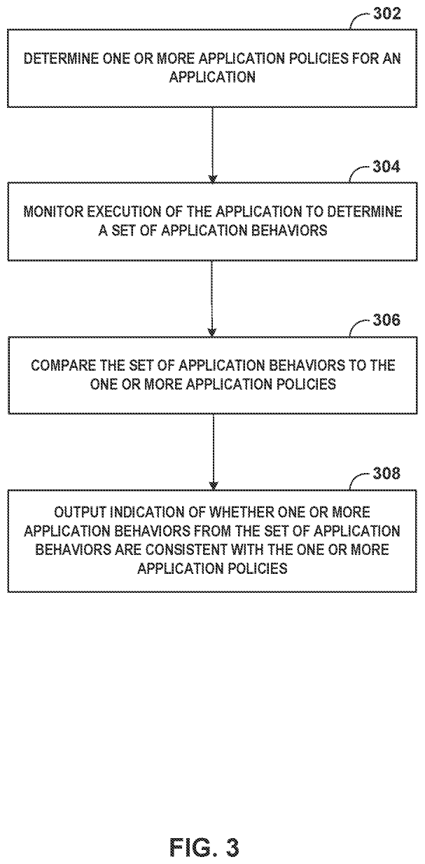

FIG. 3 is a flowchart illustrating an example mode of operation for an application behavior validation system, in accordance with one or more aspects of the present disclosure. FIG. 3 is described below in the context of computing system 102 of FIGS. 1 and computing system 202 of FIG. 2.

NLP module 216 may determine, based on application policy information for an application, one or more application policies for the application (302). For example, NLP module 216 may apply one or more classifiers to one or more segments of the application policies information to generate labels for the segments. The labels may indicate what type of policy, what type of data, what permissions, etc. the application policy describes.

App behavior module 218 may monitor execution of the application to determine a set of application behaviors (304). In some examples, app behavior module 218 may monitor the execution by, for example, causing one or more remote devices to execute the application and send, to computing system 202, an application behavior report. In other examples, app behavior module 218 causes computing system 202 to execute the application and app behavior module 218 directly monitors the application behaviors. Application behaviors monitored by app behavior module 218 may include network traffic, device permissions requested, types of data requested or used, SDKs used by the application, etc.

After app behavior module 218 monitors the execution of the application, policy comparison module 220 may compare the set of application behaviors to the one or more application policies (306). For example, policy comparison module 220 may determine if the data sent over the network to one or more remote servers is consistent with the types of data sent to remove servers as set forth in the application policy information. As another example, policy comparison module 220 may determine if device permissions requested by the application match the device permissions set forth in the application policy information.

App analysis module 210 may output an indication of whether one or more application behaviors from the set of application behaviors are consistent with the one or more application policies (308). The indication of the output may include a report that sets forth each of the possible inconsistencies between the application behavior and the application policy information. The report may be any form, such as a web page, and may include both textual and graphical information. Computing system 202 may display the indication using user interface components 206 or may send the indication to a different computing device for storage and/or display.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

Example 1: A method comprising: determining, by a computing system and based on application policy information for an application, one or more application policies for the application; monitoring, by the computing system, execution of the application to determine a set of application behaviors; comparing, by the computing system, the set of application behaviors to the one or more application policies; and outputting, by the computing system, an indication of whether one or more application behaviors from the set of application behaviors are consistent with the one or more application policies.

Example 2. The method of example 1, wherein determining the one or more application policies comprises: applying, by the computing system, a set of natural language processing classifiers to the application policy information for the application to generate the one or more application policies.

Example 3. The method of example 2, further comprising: training a first set of natural language processing classifiers as binary classification models; and training, using the first set of natural language processing classifiers, a second set of natural language processing classifiers as multi-label classification models, wherein applying the set of natural language processing classifiers to the application policy information includes applying the multi-label classification models to the application policy information, and wherein the one or more application policies include a respective policy label for one or more segments of the application policy information.

Example 4. The method of example 3, wherein training the first set of natural language processing classifiers comprises: indexing a series of application policies; receiving a query for a particular type of data; responsive to receiving the query, outputting a set of query results that includes application policy information of the particular type of data; generating, based on the set of query results, an initial training data set; and training the first set of natural language processing classifiers using the initial training data set.

Example 5. The method of any of examples 1-4, wherein the application policy information includes a set of user specified application policy information or a set of third party specified application policy information.

Example 6. The method of any of examples 1-5, further comprising, prior to determining the one or more application policies: monitoring, by the computing system, execution of the application to determine an initial set of application behaviors; and determining, based on the initial set of application behaviors, proposed application policy information.

Example 7. The method of any of examples 1-6, wherein determining the one or more application policies, monitoring the execution of the application, and comparing the set of application behaviors to the one or more applications policies are performed by an application store provider in response to determining that an update to the application was submitted to the application store provider.

Example 8. The method of any of examples 1-7, wherein the application is a web application.

Example 9. The method of any of examples 1-8, wherein the computing system is an end user computing system, wherein the application is installed and executed as the end user computing system, wherein outputting the indication of whether the one or more application behaviors from the set of application behaviors are consistent with the one or more application policies includes outputting, for display by a display device of the computing system, a web page including information about one or more application behaviors that are inconsistent with at least one of the one or more application policies.

Example 10. The method of example 9, further comprising: receiving, by the computing system, a request to uninstall the application; and uninstalling, by the computing system, the application in response to receiving the request.

Example 11. The method of any of examples 1-10, wherein outputting the indication of whether the one or more application behaviors from the set of application behaviors are consistent with the one or more application policies includes sending a report to a developer associated with the application.

Example 12. A computing system comprising: a memory that stores one or more modules; and one or more processors. The one or more processors, when executing the one or more modules, are configured to: determine, based on application policy information for an application, one or more application policies for the application; monitor execution of the application to determine a set of application behaviors; compare the set of application behaviors to the one or more application policies; and output an indication of whether one or more application behaviors from the set of application behaviors are consistent with the one or more application policies.

Example 13. The computing system of example 12, wherein the one or more processors are configured to determine the one or more application policies by at least being configured to apply a set of natural language processing classifiers to the application policy information for the application to generate the one or more application policies.

Example 14. The computing system of example 13, wherein the one or more processors are further configured to: train a first set of natural language processing classifiers as binary classification models; and train, using the first set of natural language processing classifiers, a second set of natural language processing classifiers as multi-label classification models, wherein applying the set of natural language processing classifiers to the application policy information includes applying the multi-label classification models to the application policy information, and wherein the one or more application policies include a respective policy label for one or more segments of the application policy information.

Example 15. The computing system of example 14, wherein the one or more processors are configured to train the first set of natural language processing classifiers by at least being configured to: index a series of application policies; receive a query for a particular type of data; responsive to receiving the query, output a set of query results that includes application policy information of the particular type of data; generate, based on the set of query results, an initial training data set; and train the first set of natural language processing classifiers using the initial training data set.

Example 16. The computing system of any of examples 12-15, wherein the application policy information includes a set of user specified application policy information or a set of third party specified application policy information.

Example 17. The computing system of any of examples 12-16, wherein the one or more processors are further configured to, prior to determining the one or more application policies: monitor execution of the application to determine an initial set of application behaviors; and determine, based on the initial set of application behaviors, proposed application policy information.

Example 18. The computing system of any of examples 12-17, wherein the one or more processors are configured to determine the one or more application policies, monitor the execution of the application, and compare the set of application behaviors to the one or more applications policies by an application store provider in response to determining that an update to the application was submitted to the application store provider.

Example 19. The computing system of any of examples 12-18, wherein the application is a web application.

Example 20. The computing system of any of examples 12-19, wherein the computing system is an end user computing system, wherein the application is installed and executed as the end user computing system, wherein the one or more processors are further configured to output the indication of whether the one or more application behaviors from the set of application behaviors are consistent with the one or more application policies by at least being configured to output, for display by a display device of the computing system, a web page including information about one or more application behaviors that are inconsistent with at least one of the one or more application policies.

Example 21. The computing system of example 20, wherein the one or more processors are further configured to: receive a request to uninstall the application; and uninstall the application in response to receiving the request.

Example 22. The computing system of any of examples 12-21, wherein the one or more processors are configured to output the indication of whether the one or more application behaviors from the set of application behaviors are consistent with the one or more application policies by at least being configured to send the indication to a developer associated with the application.

Example 23. A non-transitory computer-readable storage medium encoded with instructions that, when executed by one or more processors of a computing device, cause the one or more processors to: determine, based on application policy information for an application, one or more application policies for the application; monitor execution of the application to determine a set of application behaviors; compare the set of application behaviors to the one or more application policies; and output an indication of whether one or more application behaviors from the set of application behaviors are consistent with the one or more application policies.

Example 24. The non-transitory computer-readable storage medium of example 23, wherein the instructions cause the one or more processors to determine the one or more application policies by at least being causing the one or more processors to apply a set of natural language processing classifiers to the application policy information for the application to generate the one or more application policies.

Example 25. The non-transitory computer-readable storage medium of example 24, wherein the instructions further cause the one or more processors to: train a first set of natural language processing classifiers as binary classification models; and train, using the first set of natural language processing classifiers, a second set of natural language processing classifiers as multi-label classification models, wherein applying the set of natural language processing classifiers to the application policy information includes applying the multi-label classification models to the application policy information, and wherein the one or more application policies include a respective policy label for one or more segments of the application policy information.

Example 26. The non-transitory computer-readable storage medium of example 25, wherein the instructions further cause the one or more processors to: index a series of application policies; receive a query for a particular type of data; responsive to receiving the query, output a set of query results that includes application policy information of the particular type of data; generate, based on the set of query results, an initial training data set; and train the first set of natural language processing classifiers using the initial training data set.

Example 27. The non-transitory computer-readable storage medium of any of examples 23-26, wherein the application policy information includes a set of user specified application policy information or a set of third party specified application policy information.

Example 28. The non-transitory computer-readable storage medium of any of examples 23-27, wherein the instructions further cause the one or more processors to, prior to determining the one or more application policies: monitor execution of the application to determine an initial set of application behaviors; and determine, based on the initial set of application behaviors, proposed application policy information.

Example 29. The non-transitory computer-readable storage medium of any of examples 23-28, wherein the instructions cause the one or more processors to determine the one or more application policies, monitor the execution of the application, and compare the set of application behaviors to the one or more applications policies by an application store provider in response to determining that an update to the application was submitted to the application store provider.

Example 30. The non-transitory computer-readable storage medium of any of examples 23-29, wherein the application is a web application.

Example 31. The non-transitory computer-readable storage medium of any of examples 23-30, wherein the computing device is an end user computing device, wherein the application is installed and executed as the end user computing device, wherein the instructions cause the one or more processors to output the indication of whether the one or more application behaviors from the set of application behaviors are consistent with the one or more application policies by at least being causing the one or more processors to output, for display by a display device of the computing device, a web page including information about one or more application behaviors that are inconsistent with at least one of the one or more application policies.

Example 32. The non-transitory computer-readable storage medium of example 31, wherein the instructions further cause the one or more processors to: receive a request to uninstall the application; and uninstall the application in response to receiving the request.

Example 33. The non-transitory computer-readable storage medium of any of examples 23-32, wherein the instructions cause the one or more processors to output the indication of whether the one or more application behaviors from the set of application behaviors are consistent with the one or more application policies by at least causing the one or more processors to send the indication to a developer associated with the application.

Example 34. A non-transitory computer-readable storage medium storing instructions that, when executed, cause one or more processors of a computing device to perform any of the methods of examples 1-11.

Example 35. A computing device comprising means for performing the method recited by any combination of claims 1-11.

Various examples of the invention have been described. These and other examples are within the scope of the following claims.

1. A method comprising:
determining, by a computing system and based on application policy information for an application, one or more application policies for the application;
monitoring, by the computing system, execution of the application to determine a set of application behaviors;
comparing, by the computing system, the set of application behaviors to the one or more application policies; and
outputting, by the computing system, an indication of whether one or more application behaviors from the set of application behaviors are consistent with the one or more application policies.

2. The method of claim 1, wherein determining the one or more application policies comprises:
applying, by the computing system, a set of natural language processing classifiers to the application policy information for the application to generate the one or more application policies.

3. The method of claim 2, further comprising:
training a first set of natural language processing classifiers as binary classification models; and
training, using the first set of natural language processing classifiers, a second set of natural language processing classifiers as multi-label classification models,
wherein applying the set of natural language processing classifiers to the application policy information includes applying the multi-label classification models to the application policy information, and
wherein the one or more application policies include a respective policy label for one or more segments of the application policy information.

4. The method of claim 3, wherein training the first set of natural language processing classifiers comprises:
indexing a series of application policies;
receiving a query for a particular type of data;
responsive to receiving the query, outputting a set of query results that includes application policy information of the particular type of data;
generating, based on the set of query results, an initial training data set; and
training the first set of natural language processing classifiers using the initial training data set.

5. The method of claim 1, wherein the application policy information includes a set of user specified application policy information or a set of third party specified application policy information.

6. The method of claim 1, further comprising, prior to determining the one or more application policies:
monitoring, by the computing system, execution of the application to determine an initial set of application behaviors; and
determining, based on the initial set of application behaviors, proposed application policy information.

7. The method of claim 1, wherein determining the one or more application policies, monitoring the execution of the application, and comparing the set of application behaviors to the one or more applications policies are performed by an application store provider in response to determining that an update to the application was submitted to the application store provider.

8. The method of claim 1, wherein the application is a web application.

9. The method of claim 1, wherein the computing system is an end user computing system, wherein the application is installed and executed as the end user computing system, wherein outputting the indication of whether the one or more application behaviors from the set of application behaviors are consistent with the one or more application policies includes outputting, for display by a display device of the computing system, a web page including information about one or more application behaviors that are inconsistent with at least one of the one or more application policies.

10. The method of claim 9, further comprising:
receiving, by the computing system, a request to uninstall the application; and
uninstalling, by the computing system, the application in response to receiving the request.

11. The method of claim 1, wherein outputting the indication of whether the one or more application behaviors from the set of application behaviors are consistent with the one or more application policies includes sending a report to a developer associated with the application.

12. A computing system comprising:
a memory that stores one or more modules; and
one or more processors that, when executing the one or more modules, are configured to:
determine, based on application policy information for an application, one or more application policies for the application;
monitor execution of the application to determine a set of application behaviors; compare the set of application behaviors to the one or more application policies; and
output an indication of whether one or more application behaviors from the set of application behaviors are consistent with the one or more application policies.

13-14. (canceled)

15. The computing system of claim 12,
wherein the one or more processors are configured to determine the one or more application policies by at least being configured to apply a set of natural language processing classifiers to the application policy information for the application to generate the one or more application policies;
wherein the one or more processors are further configured to:
index a series of application policies;
receive a query for a particular type of data;
responsive to receiving the query, output a set of query results that includes application policy information of the particular type of data;
generate, based on the set of query results, an initial training data set;
train a first set of natural language processing classifiers using the initial training data set as binary classification models; and
train, using the first set of natural language processing classifiers, a second set of natural language processing classifiers as multi-label classification models, wherein applying the set of natural language processing classifiers to the application policy information includes applying the multi-label classification models to the application policy information, and wherein the one or more application policies include a respective policy label for one or more segments of the application policy information.

16. The computing system of claim 12, wherein the application policy information includes a set of user specified application policy information or a set of third party specified application policy information.

17. The computing system of claim 12, wherein the one or more processors are further configured to, prior to determining the one or more application policies:
monitor execution of the application to determine an initial set of application behaviors; and
determine, based on the initial set of application behaviors, proposed application policy information.

18. The computing system of claim 12, wherein the one or more processors are configured to determine the one or more application policies, monitor the execution of the application, and compare the set of application behaviors to the one or more applications policies by an application store provider in response to determining that an update to the application was submitted to the application store provider.

19. A non-transitory computer-readable storage medium encoded with instructions that, when executed by one or more processors of a computing device, cause the one or more processors to:
determine, based on application policy information for an application, one or more application policies for the application;
monitor execution of the application to determine a set of application behaviors;
compare the set of application behaviors to the one or more application policies; and
output an indication of whether one or more application behaviors from the set of application behaviors are consistent with the one or more application policies.

20. The non-transitory computer-readable storage medium of claim 19,
wherein, to determine the one or more application policies, the instructions cause the one or more processors to apply a set of natural language processing classifiers to the application policy information for the application to generate the one or more application policies; and
wherein the instructions further causes the one or more processors to:
index a series of application policies;
receive a query for a particular type of data;
responsive to receiving the query, output a set of query results that includes application policy information of the particular type of data;
generate, based on the set of query results, an initial training data set;
train a first set of natural language processing classifiers using the initial training data set as binary classification models; and
train, using the first set of natural language processing classifiers, a second set of natural language processing classifiers as multi-label classification models, wherein applying the set of natural language processing classifiers to the application policy information includes applying the multi-label classification models to the application policy information, and wherein the one or more application policies include a respective policy label for one or more segments of the application policy information.

21. The non-transitory computer-readable storage medium of claim 19, wherein the instructions cause the one or more processors to, prior to determining the one or more application policies:
monitor execution of the application to determine an initial set of application behaviors; and
determine, based on the initial set of application behaviors, proposed application policy information.

22. The non-transitory computer-readable storage medium of claim 19, wherein the instructions cause the one or more processors to determine the one or more application policies, monitor the execution of the application, and compare the set of application behaviors to the one or more applications policies by an application store provider in response to determining that an update to the application was submitted to the application store provider.
